(19) United States
(12) Patent Application Publication
(10) Pub. No.: US 2017/0297426 A1
(43) Pub. Date: Oct. 19, 2017

(54) SYSTEM AND METHOD FOR GROUNDING A FUEL INTAKE SYSTEM

(71) Applicant: ILLINOIS TOOL WORKS INC., Glenview, IL (US)

(72) Inventors: Stephen M. SPERANDO, Glen Ellyn, IL (US); Paul M. SUTENBACH, Highland Park, IL (US); Edward S. KRAMER, Glencoe, IL (US); Alexander M. KERSTEIN, Chicago, IL (US)

(21) Appl. No.: 15/518,093

(22) PCT Filed: Jul. 24, 2015
(86) PCT No.: PCT/US2015/042041

§ 371 Date: Apr. 10, 2017

Related U.S. Application Data
(60) Provisional application No. 62/065,065, filed on Oct. 17, 2014.

(51) Int. Cl. B60K 15/04; B29C 45/72; B67D 7/32; B29C 45/00; B29C 45/26; B60K 15/05; B29L 31/30; B67D 7/04; B29L 31/00

(52) U.S. Cl. CPC B60K 15/04; B29C 45/2602; B29C 45/7207; B67D 7/3236; B29C 45/0001; B60K 2015/0461; B29L 2031/749; B29L 2031/30; B29K 2995/0005; B60K 2015/047; B60K 2015/0483; B60K 2015/0515; B67D 7/04; B60K 15/05

(57) ABSTRACT

Embodiments of the present disclosure provide a method of forming a cover of a fuel intake system of a vehicle. The method may include providing a mold that defines a cover-forming cavity having a main body portion and a grounding strap portion connected to the main body portion, inputting a forming material into the cover-forming cavity to a specified level, allowing the forming material within the cover-forming cavity to cool and harden, separating the mold to expose the cover having an integrally molded and formed grounding strap, and removing the formed cover having the integrally molded and formed grounding strap from the separated mold.

### RELATED APPLICATIONS

This application relates to and claims priority benefits from U.S. Provisional Patent Application No. 62/065,065 entitled “System and Method for Grounding a Fuel Nozzle Receiving Assembly During Refueling,” filed Oct. 17, 2014, which is hereby incorporated by reference in its entirety.

### FIELD OF EMBODIMENTS OF THE DISCLOSURE

Embodiments of the present disclosure generally relate to fuel nozzle receiving systems of vehicles, and more particularly, to systems and methods for grounding fuel intake systems.

### BACKGROUND

Various vehicles, such as automobiles, are powered by gasoline, diesel fuel, or the like. As such, the vehicles typically include fuel systems having a tank configured to retain fuel, such as gasoline or diesel fuel, and a fuel fill pipe that serves as an inlet for supplying fuel to the tank from a fuel nozzle of a refueling station. In general, a fuel fill pipe includes an opening that may be exposed during refueling in order to receive the nozzle. An exposed end portion of the fuel pipe is of sufficient size to receive a discharge tube of a refueling nozzle. The nozzle typically fits relatively loosely in the fuel fill pipe so that the nozzle may be quickly and easily inserted and removed from the fuel fill pipe.

As a fuel nozzle is inserted into a fuel nozzle receiving system, static electricity that has built on the fuel nozzle may be transferred to a door of the fuel nozzle receiving system. In order to prevent sparking, the fuel nozzle receiving system is grounded. The door of the fuel nozzle receiving system is generally conductive. When the fuel nozzle abuts against the door, a conductive path is formed between the fuel nozzle and the conductive door. The door connects to a biasing spring, which connects to an outer pipe of the fuel nozzle receiving system. The pipe is, in turn, grounded to the vehicle. Accordingly, static electricity on the fuel nozzle is discharged to ground by traveling from the door to the spring, and then to ground via the spring and pipe.

However, if the pipe is non-conductive, such as a non-conductive plastic pipe, then the conductive path between the spring and pipe is not present. As such, a conductive plastic pipe may be used, and a separate and distinct metal grounding strap, such as formed of copper, may be connected between the conductive pipe and ground. A separate metal stud may be attached with a heat stake to the cover and may be used to connect to an end of the grounding strap.

Notably, the metal grounding strap and stud are separate components that are assembled to the plastic pipe. Assembling the separate and distinct components increases the time and complexity of a manufacturing process.

Accordingly, a need exists for an efficient system and method of grounding a fuel intake system. A need exists for an efficient method of manufacturing a grounded fuel intake system.

### SUMMARY OF EMBODIMENTS OF THE DISCLOSURE

Certain embodiments of the present disclosure provide a fuel intake system for a vehicle. The fuel intake system may include a fuel fill pipe, and a cover connected to the fuel fill pipe. The cover includes an integrally molded and formed grounding strap extending therefrom. The grounding strap is not a separate component that separately affixed to the cover, such as through a separate and distinct fastener, heat staking, or the like.

The cover and the grounding strap may be integrally molded and formed from injection-molded plastic. In at least one embodiment, the cover and the grounding strap may be formed from conductive plastic.

The grounding strap may include a distal end that connects to ground. Optionally, the grounding strap includes a distal end that is configured to be fixed to another portion of the vehicle through one or more fasteners.

The fuel intake system may include a mis-fuel inhibitor (MFI) assembly. The MFI assembly may include the cover.

In at least one embodiment, the grounding strap may include an extension beam that outwardly extends from an outer surface of the cover, an arcuate segment connected to the extension beam, an extension segment connected to the arcuate segment, and a hooked end connected to the extension segment. In at least one other embodiment, the grounding strap includes a loop defining an internal opening. A portion of a fastener that connects to another portion of the vehicle is configured to be retained within the internal opening.

Certain embodiments of the present disclosure provide a cover configured to connect to a fuel fill pipe of a fuel intake system of a vehicle. The cover includes a main body having an outer surface, and a grounding strap integrally molded and formed with the main body and extending from the outer surface. The main body and the grounding strap may be formed from conductive plastic. The grounding strap is not separately affixed to the main body. The cover may be part of a mis-fuel inhibitor (MFI) assembly.

Certain embodiments of the present disclosure provide a method of forming a cover of a fuel intake system of a vehicle. The method may include providing a mold that defines a cover-forming cavity having a main body portion and a grounding strap portion connected to the main body portion, inputting a forming material into the cover-forming cavity to a specified level, allowing the forming material within the cover-forming cavity to cool and harden, separating the mold to expose the cover having an integrally molded and formed grounding strap, and removing the formed cover having the integrally molded and formed grounding strap from the separated mold.

### BRIEF DESCRIPTION OF SEVERAL VIEWS OF THE DRAWINGS

FIG. 1 illustrates a perspective view of a fuel intake system, according to an embodiment of the present disclosure.

FIG. 2 illustrates a perspective front view of a mis-fuel inhibitor (MFI) assembly secured to a fuel fill pipe, according to an embodiment of the present disclosure.

FIG. 3 illustrates an internal cross-sectional view of an MFI assembly secured to a fuel fill pipe through line 3-3 of FIG. 2, according to an embodiment of the present disclosure.

FIG. 4 illustrates an internal cross-sectional view of an MFI assembly secured to a fuel fill pipe, according to an embodiment of the present disclosure.

FIG. 5 illustrates a perspective lateral view of a fuel intake system, according to an embodiment of the present disclosure.

FIG. 6 illustrates a perspective lateral view of a fuel intake system, according to an embodiment of the present disclosure.

FIG. 7 illustrates a perspective lateral view of a fuel intake system, according to an embodiment of the present disclosure.

FIG. 8 illustrates an internal view of a mold configured to form a cover having an integrally molded and formed grounding strap, according to an embodiment of the present disclosure.

FIG. 9 illustrates a flow chart of integrally molding and forming a grounding strap with a cover of a fuel intake system, according to an embodiment of the present disclosure.

Before the embodiments of the disclosure are explained in detail, it is to be understood that the disclosure is not limited in its application to the details of construction and the arrangement of the components set forth in the following description or illustrated in the drawings. The disclosure is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF EMBODIMENTS OF THE DISCLOSURE

Embodiments of the present disclosure provide a fuel intake system that includes a cover having an integrally molded and formed grounding strap. Accordingly, embodiments of the present disclosure eliminate the need for a separate and distinct grounding strap that is separately secured to a cover. As such, embodiments of the present disclosure provide a simpler, more efficient fuel intake system. By integrally molding and forming the grounding strap with the cover, the manufacturing process is streamlined and simplified.

The cover may include a molded-in grounding strap, which may be formed of a conductive plastic, which is less costly than a metal grounding strap, such as formed of copper, for example. Embodiments of the present disclosure eliminate the need for a separate, costly metal grounding strap.

The cover and integrally molded and formed grounding strap may be formed of various plastics, which may be mixed with conductive carbon fiber, conductive carbon powder, and/or the like. The cover and grounding strap may be formed through plastic injection molding processes, for example. The grounding strap may be connected to ground through heat staking, for example. As another example, an end of the grounding strap may be secured to a portion of the vehicle, such as through one or more fasteners (for example, one or more screws).

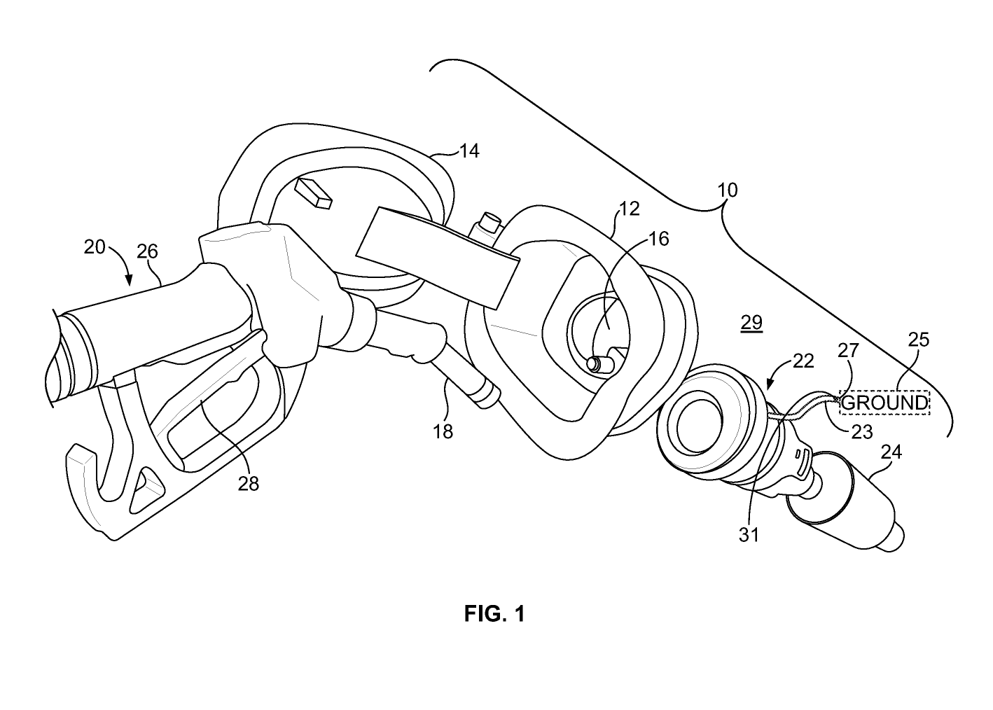

FIG. 1 illustrates a perspective view of a fuel intake system 10, according to an embodiment of the present disclosure. The fuel intake system 10 may include a nozzle-receiving housing 12, which may be secured to a frame of a vehicle, for example. The nozzle-receiving housing 12 may include a door 14 that pivotally connects to the housing 12. The door 14 is configured to be pivoted between open and closed positions. The housing 12 defines an opening 16 into which a nozzle 18 of a fuel-dispensing device 20 may be inserted.

The housing 12 may directly or indirectly connect to an improper fuel nozzle insertion-inhibiting assembly, such as a mis-fuel inhibitor (MFI) assembly 22. Optionally, instead of an MFI assembly 22, the fuel intake system 10 may include a cover that covers or otherwise connects to an end of a fuel fill line. An integrally molded and formed grounding strap 23 may extend from a cover of the MFI assembly 22. For example, the grounding strap 23 may be formed of a conductive plastic and may be integrally formed and molded with a portion of the MFI assembly 22, such as a cover, outer pipe, or the like. Alternatively, or additionally, the grounding strap 23 and/or another grounding strap may be integrally molded and formed with another portion of the fuel intake system 10, such as the nozzle-receiving housing 12.

The grounding strap 23 may connect to ground 25, such as through heat staking. In at least one other embodiment, the grounding strap 23 may be secured to a portion of the vehicle (such as an internal frame), such as through one or more fasteners (for example, one or more screws). For example, a distal end 27 of the grounding strap 23 may be securely fastened to an internal frame 29 of a vehicle through a fastener 31. The internal frame 29 may provide a path to ground 25. In this manner, the grounding strap 23 provides a path for static charge build-up to discharge to ground 25.

The MFI assembly 22 is configured to prevent improper fuel-dispensing devices (for example, fuel-dispensing devices that are incompatible with the fuel intake system 10) from dispensing fuel into a fuel fill pipe 24 connected to the MFI assembly 22. For example, the MFI assembly 22 prevents a diesel fuel-dispensing device from being inserted into a gasoline fuel intake system, or vice versa. That is, a diesel fuel-dispensing device is an improper or incompatible fuel-dispensing device in relation to a gasoline fuel intake system, while a gasoline fuel-dispensing device is an improper or incompatible fuel-dispensing device in relation to a diesel fuel intake system. As noted above, however, the fuel intake system 10 may not include the MFI assembly 22. Instead, the fuel intake system 10 may include a cover having the integrally molded and formed grounding strap 23.

The fuel-dispensing device 20 includes a handle 26 operatively connected to a trigger 28. The handle 26 is configured to be grasped by an operator and connects to the nozzle 18.

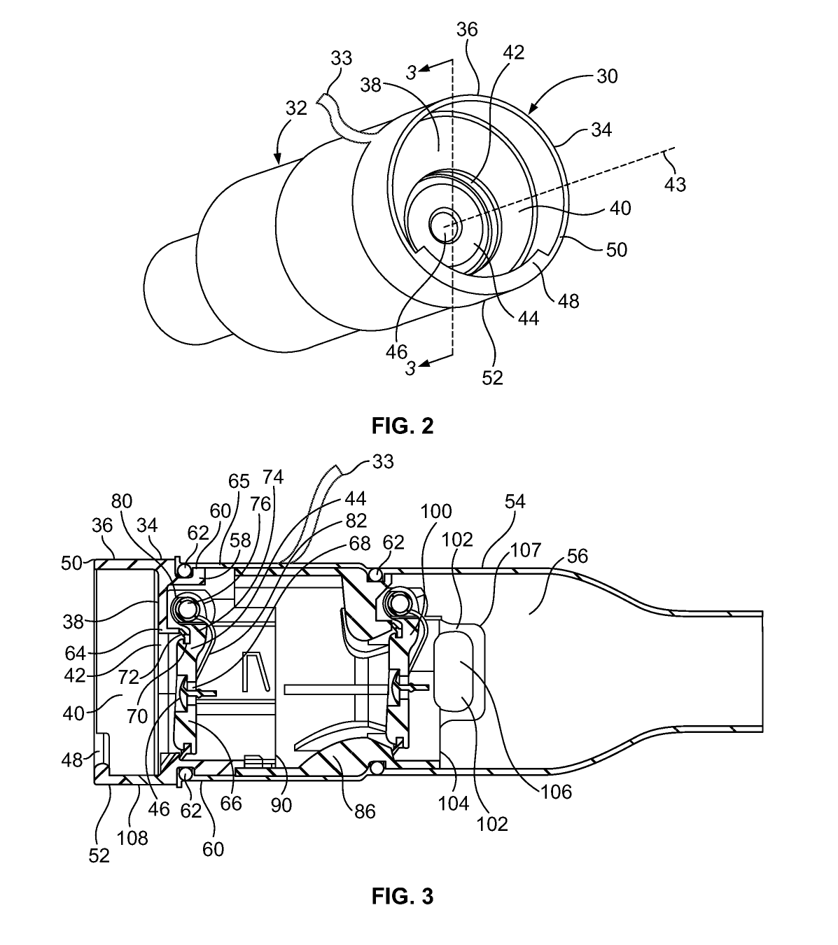

FIG. 2 illustrates a perspective front view of a mis-fuel inhibitor (MFI) assembly 30 secured to a fuel fill pipe 32, according to an embodiment of the present disclosure. The MFI assembly 30 includes a cover 34 having a circumferential wall 36. A grounding strap 33 may be integrally molded and formed with the cover 34 and extend outwardly therefrom. Alternatively, the grounding strap 33 may be integrally formed and molded with another portion of the MFI assembly 30. The grounding strap 33 may connect to ground, as described above with respect to FIG. 1.

In at least one other embodiment, the MFI assembly 30 shown in FIG. 2 may alternatively be a cover that connects to the fuel fill pipe 32. The grounding strap 33 may be integrally formed and molded with the cover.

The circumferential wall 36 may be circular in cross-section and connects to a front face wall 38 that may be generally perpendicular to the circumferential wall 36. For example, the front face wall 38 may form a base from which the circumferential wall 36 outwardly extends. An open nozzle-receiving cavity 40 is defined between the circumferential wall 36 and the front face wall 38. A channel 42 is formed through the front face wall 38. The channel 42 provides an inlet for a nozzle-receiving passage that extends through an internal chamber of the MFI assembly 30. A nozzle inlet barrier door 44 is pivotally secured within the channel 42. A pressure-relief valve 46 may be secured within the nozzle inlet barrier wall 44. Alternatively, the pressure-relief valve 46 may not be secured to the nozzle inlet barrier door 44. Instead, the nozzle inlet barrier door 44 may simply include a contiguous covering panel.

An arcuate nozzle-latching member 48, such as a ridge, rim, lip, or the like, may inwardly and radially extend from the circumferential wall 36 toward a central longitudinal axis 43 of the MFI assembly 30. The nozzle-latching member 48 may inwardly extend from a front edge 50 of the circumferential wall 36 and may generally conform to the curvature of the circumferential wall 36. The nozzle-latching member 48 may extend inwardly from a bottom 52 of the circumferential wall 36 over a radial angle of approximately 45°. Alternatively, the nozzle-latching member 48 may extend over distances that are greater or less than a radial angle of 45°. For example, the nozzle-latching member 48 may extend around an entire internal diameter of the circumferential wall 36. Additionally, the nozzle-latching member 48 may optionally be positioned further toward the front face wall 38, instead of the front edge 50. As shown in FIG. 2, however, the nozzle-latching member 48 is within the cavity 40 outside of the nozzle inlet barrier door 44.

FIG. 3 illustrates an internal cross-sectional view of the MFI assembly 30 secured to the fuel fill pipe 32 through line 3-3 of FIG. 2, according to an embodiment of the present disclosure. The fuel fill pipe 32 may include an inlet pipe 54 defining an internal channel 56 that connects to a fuel tank (not shown).

The circumferential wall 36 of the MFI assembly 30 connects to a main body 58 or nozzle guide that is secured to the internal channel 56 of the inlet pipe 54. For example, the main body 58 may have an outer diameter that is less than that of the internal channel 56 of the inlet pipe 54, while the diameter of the circumferential wall 36 is greater than the diameter of the internal channel 56. As such, the main body 58 may be slid into the internal channel 56 until the circumferential wall 36 abuts against the inlet pipe 54. The main body 58 may securely connect to the inlet pipe 54 through an interference fit, for example.

The main body 58 may include a ledge 60 connected to the circumferential wall 36. The ledge 60 may retain a sealing member 62, such as an elastomeric gasket, O-ring, or the like, that provides a seal between the main body 58 and the inlet pipe 54. Optionally, the main body 58 may include a radially-extending flange over which a seal member is secured. For example, a circumferential seal member may be overmolded directly onto and around the flange.

As shown in FIG. 3, the grounding strap 33 extends outwardly from a portion of the cover 65, such as the main body 58 or wall connected thereto, of the MFI assembly 30. The grounding strap 33 may be formed of the same material as the cover, such as a conductive plastic, and may be integrally formed and molded therewith. For example, the cover and the grounding strap 33 may be integrally formed and molded within a mold. Plastic may be injected into the mold to integrally mold and form the cover and the grounding strap 33.

The grounding strap 33 is integrally formed and molded with the cover 65, which connects to the fuel fill pipe 32. The cover 65 may be part of an MFI assembly. Optionally, the cover 65 may not be part of an MFI assembly. For example, the cover 65 may simply connect the fuel fill pipe 32 to a portion of a vehicle.

As noted above, the nozzle inlet barrier door 44 is pivotally secured within the channel 42. The channel 42 is defined by an inwardly-directed tubular wall 64 that is generally perpendicular to the front face wall 38 and parallel with the circumferential wall 36.

The nozzle inlet barrier door 44 may include a covering panel 66 having a valve-retaining opening 68 formed therein. The valve-retaining opening 68 retains the pressure-relief valve 46. When internal pressure exceeds a particular pre-defined threshold, the pressure-relief valve 46 may be forced open in relation to the valve-retaining opening 68, to allow fluid pressure to be released through the valve-retaining opening 68. When the pressure drops below the pre-defined threshold, the pressure-relief valve 46 re-seats on the covering panel 66, thereby closing the valve-retaining opening 68.

The covering panel 66 may include a circumferential slot 70 that retains a radial seal 72 that outwardly and radially extends from the covering panel 66. In the closed position, the radial seal 72 sealingly engages the wall 64, thereby preventing fluid and debris, such as dust, from passing into an internal chamber 90 of the MFI assembly 30. Alternatively, instead of, or in addition to, the radial seal extending from the covering panel 66, a seal may radially extend inwardly from the wall 64 of the main body 58.

The nozzle inlet barrier door 44 also includes a hinge 74 that extends rearwardly from the covering panel 66. The hinge 74 includes integrally formed posts 76 that extend outwardly from an upper portion of the hinge 74. The posts 76 may define a pivot axle. For example, two opposed posts 76 may extend from an upper portion of the hinge 74. The posts 76 are pivotally secured within reciprocal post-receiving channels 80 of an axle bearing formed in the main body 58 behind the front face wall 38. As such, the nozzle inlet barrier door 44 may pivotally connect to the main body 58 of the cover 34 without the use of separate and distinct pins, for example. Alternatively, the nozzle inlet barrier door 44 may pivotally connect to the main body 58 through one or more pins.

One or more torsion springs 82 may be operatively connected to the hinge 74 and a rear surface of the covering panel 66. The torsion spring(s) 82 ensure that the nozzle inlet barrier door 44 remains in a closed position. The torsion spring(s) 82 resist force that tends to pivot the nozzle inlet barrier door 44 into an open position, such as a vacuum force produced within a fuel tank. Alternatively, the MFI assembly 30 may not include the torsion spring(s) 82. Instead, the nozzle inlet barrier door 44 may exert sufficient resistive force to ensure that the nozzle inlet barrier door 44 remains closed.

The main body 58 may also include internal restricting members 86 downstream (in relation to a location where a fuel nozzle is inserted and urged into the MFI assembly 30) from the nozzle inlet barrier door 44. The restricting members 86 may be inwardly directed ribs, fins, panels, or the like that effectively reduce the internal diameter of the internal chamber 90 of the MFI assembly 30. For example, a diameter of a nozzle passage area within the internal chamber 90 proximate to the nozzle inlet barrier door 44 is greater than a diameter of a nozzle passage area within the internal chamber 90 proximate to a nozzle outlet barrier door 100 that covers a nozzle channel. Thus, while a nozzle having a particular diameter may be able to pass into the internal chamber 90 through the nozzle inlet barrier door 44, the nozzle may have a diameter that is too large to pass between the restricting members 86. As such, the nozzle may be unable to abut against a front surface of the nozzle outlet barrier door 100.

The nozzle outlet barrier door 100 may be configured similar to the nozzle inlet barrier door 44. The nozzle outlet barrier door 100 may be pivotally secured to the main body 58 downstream from the restricting member 86.

The main body 58 may also include one or more snap rims 102 that extend longitudinally outward from a trailing edge 104 of the main body 58. Each snap rim 102 may be configured to snapably engage a reciprocal latch 106 (such as a protuberance that conforms to a shape of an internal opening 107 formed within the snap rim 102) of the fuel fill pipe 32 that inwardly protrudes into the internal channel 56. In this manner, the snap rim(s) 102 securely connect the MFI assembly 30 to the fuel fill pipe 32.

As shown, an additional sealing member 62 may sealingly connect the main body 58 to the inlet pipe 54 proximate to the nozzle outlet barrier door 100. Alternatively, the MFI assembly 30 may include more or less sealing members 62 than shown.

The MFI assembly 30 may also include a drain 108 formed through the bottom 52 of the circumferential wall 36. The drain 108 may be an open-ended passage that allows fluid that collects within the open cavity 40 to drain out of the MFI assembly 30.

As shown, when the door is opened, the spring 82 abuts into the cover 65. As such, a conductive path exists between the door 44, the spring 82, the cover 65, and the grounding strap 33.

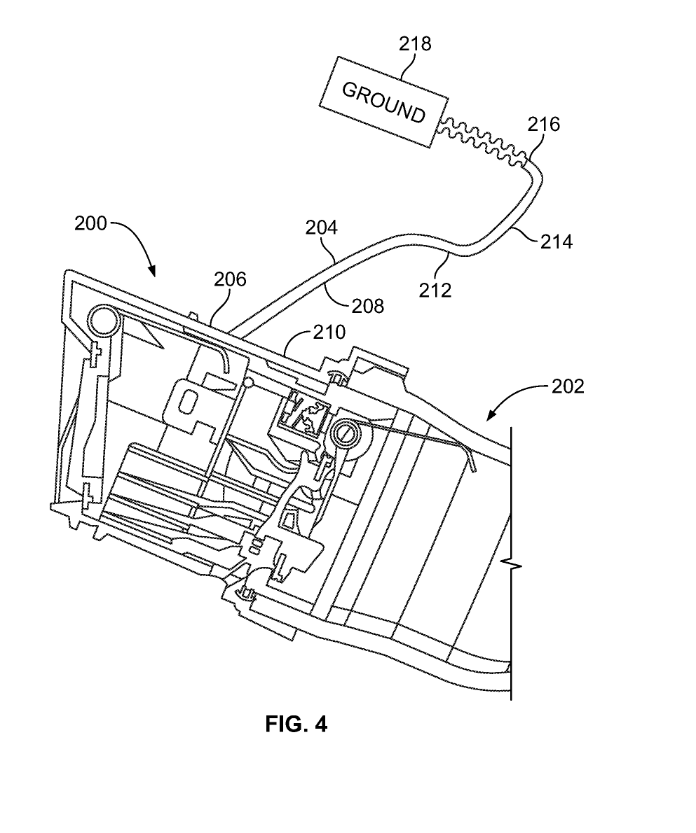

FIG. 4 illustrates an internal cross-sectional view of an MFI assembly 200 secured to the fuel fill pipe 202, according to an embodiment of the present disclosure. As shown, an integrally molded and formed conductive grounding strap 204 outwardly extends from a cover 206 of the MFI assembly 200. The cover 206 and grounding strap 204 may be integrally molded and formed, such as with conductive plastic that is injected into a mold.

The grounding strap 204 may include an extension beam 208 that outwardly extends from an outer surface 210 of the cover 206. The extension beam 208 connects to an arcuate segment 212, which may, in turn, connect to an extension segment 214. The extension segment 214 may connect to a hooked end 216. The hooked end 216 may connect to ground 218. For example, the hooked end 216 may directly contact ground 218, or may connect to ground 218 through a separate and distinct conductive conduit.

In at least one other embodiment, the grounding strap 204 may be secured to a portion of a vehicle (such as a frame portion) through one or more fasteners. In this manner, the grounding strap 204 provides a path to ground 218 through structural portions of the vehicle.

The grounding strap 204 may be rigid and set in position, as shown. In at least one other embodiment, the grounding strap 204 may be flexible and resilient. The hooked end 216 may be securely fixed to ground 218, a conduit to ground 218, a portion of the vehicle, or the like through heat staking, one or more fasteners, and/or the like.

The shape of the grounding strap 204 may be determined by a shape of a vehicle in which it is disposed. As such, the grounding strap 204 may be shaped and sized in a different manner than shown.

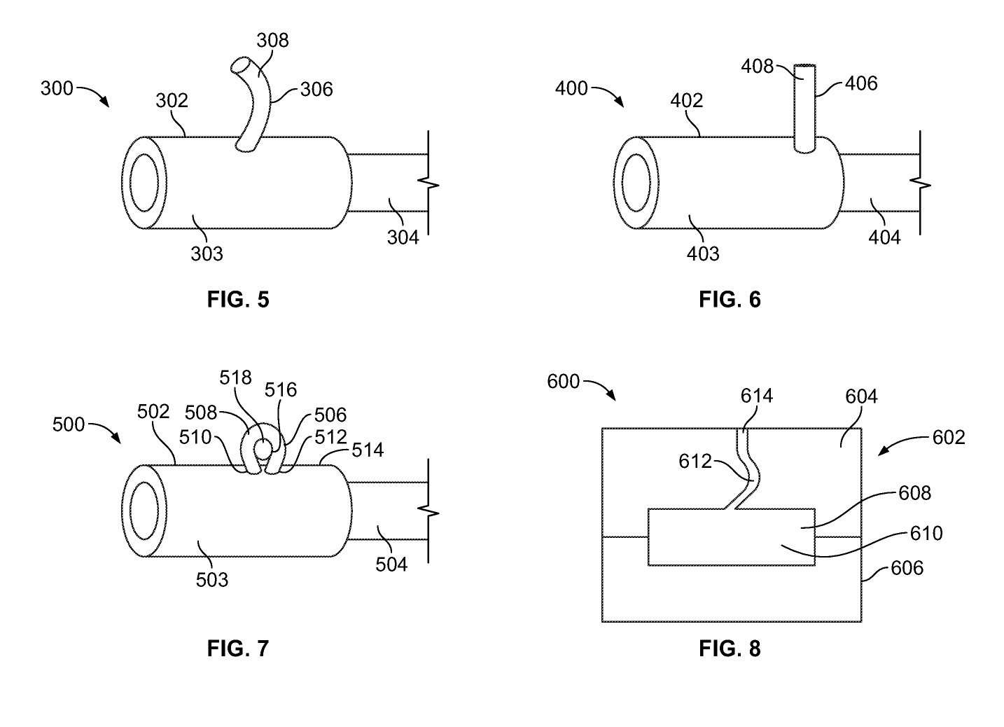

FIG. 5 illustrates a perspective lateral view of a fuel intake system 300, according to an embodiment of the present disclosure. The fuel intake system 300 includes a cover 302 having a main body 303 connected to a fuel fill pipe 304. The cover 302 may be part of an MFI assembly. In at least one other embodiment, the cover 302 is not part of an MFI assembly.

A grounding strap 306 is integrally molded and formed along with the cover 302. The grounding strap 306 extends outwardly from the cover 302. The grounding strap 306 may include a curved beam 308. Alternatively, the grounding strap 306 may be sized and shaped in a different manner than shown.

FIG. 6 illustrates a perspective lateral view of a fuel intake system 400, according to an embodiment of the present disclosure. The fuel intake system 400 includes a cover 402 having a main body 403 connected to a fuel fill pipe 404. The cover 402 may be part of an MFI assembly. In at least one other embodiment, the cover 402 is not part of an MFI assembly.

A grounding strap 406 is integrally molded and formed along with the cover 402. The grounding strap 406 extends outwardly from the cover 402. The grounding strap 406 may include a linear beam 408. Alternatively, the grounding strap 406 may be sized and shaped in a different manner than shown.

FIG. 7 illustrates a perspective lateral view of a fuel intake system 500, according to an embodiment of the present disclosure. The fuel intake system 500 includes a cover 502 having a main body 503 connected to a fuel fill pipe 504. The cover 502 may be part of an MFI assembly. In at least one other embodiment, the cover 502 is not part of an MFI assembly.

A grounding strap 506 is integrally molded and formed along with the cover 502. The grounding strap 506 extends outwardly from the cover 502. The grounding strap 506 may include a loop 508 having first and second ends 510 and 512 that integrally connect to an outer surface 514 of the cover 502. An opening 516 is defined between the loop 508 and the outer surface 514 of the cover 502. The opening 516 may be configured to retain a portion of a fastener 518 that connects to ground directly or through one or more other components. Alternatively, the grounding strap 506 may be sized and shaped in a different manner than shown.

FIGS. 1-7 illustrates various examples of grounding straps that are integrally formed and molded with a main body of a cover of a fuel intake system. The grounding straps are integral parts of the covers. As such, separate and distinct grounding members are not assembled to the covers. The grounding straps shown in FIGS. 1-7 may be sized and shaped differently than shown.

FIG. 8 illustrates an internal view of a mold 600 configured to form a cover having an integrally molded and formed grounding strap, according to an embodiment of the present disclosure. The mold 600 includes a main body 602 having a top portion 604 and a bottom portion 606. A cover-forming cavity 608 is defined between the top and bottom portions 604 and 606. The cover-forming cavity 608 includes a main body portion 610 and a grounding strap portion 612. The grounding strap portion 612 may connect to a material inlet 614. Optionally, the material inlet 614 may connect to a portion of the main body portion 610. In at least one other embodiment, multiple material inlets 614 may connect to portions of the cover-forming cavity 608.

In order to form the cover, a material such as injection-molded conductive plastic is input into the material inlet 614. The material continues to be poured or otherwise input into the material inlet 614 until the cover-forming cavity 608 is filled to a specified level, which relates to a volume of material that is used to fully form the cover including the grounding strap. The material is then allowed to cool and harden. After the material cools and hardens, the top portion 604 of the mold 600 may be separated from the bottom portion 606, thereby exposing the formed cover and integrally formed grounding strap. The cover, which includes the integrally formed grounding strap extending therefrom, may then be removed from the mold.

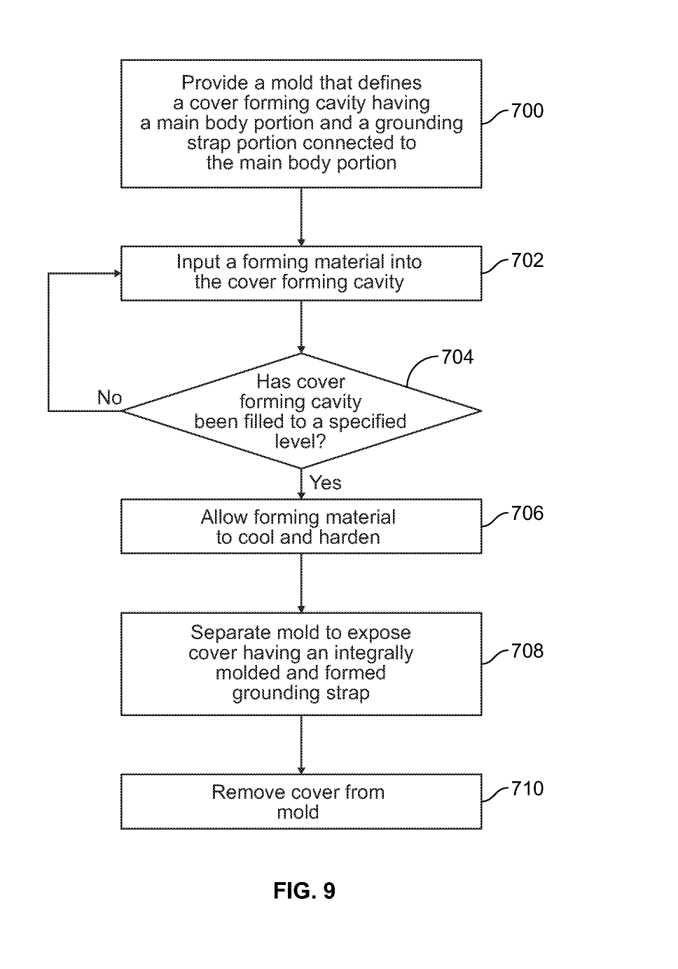

FIG. 9 illustrates a flow chart of integrally molding and forming a grounding strap with a cover of a fuel intake system, according to an embodiment of the present disclosure. At 700, a mold is provided that defines a cover-forming cavity having a main body portion and a grounding strap portion connected to the main body portion. At 702, a forming material (such as injection molded plastic) is input into the cover-forming cavity. At 704, it is determined if the cover-forming cavity has been filled to a specified level, which relates to a predetermined amount of forming material that is used to fully form a cover having an integrally molded and formed grounding strap. If the cover-forming cavity has not been filled with forming material to the specified level, the method returns to 702. If, however, the cover-forming cavity has been filled with material to the specified level, the method proceeds from 704 to 706, in which the forming material within the cover-forming cavity is allowed to cool and harden. After the forming material within the cover-forming cavity cools and hardens, at 708, the mold is separated to expose a cover having an integrally molded and formed grounding strap. Then, at 710, the cover is removed from the mold.

As described above, embodiments of the present disclosure provide a fuel intake system that includes a cover having an integrally molded and formed grounding strap, which eliminates the need for a separate and distinct grounding strap that is separately affixed to a cover. As such, embodiments of the present disclosure provide a simpler, more efficient fuel intake system. By integrally molding and forming the grounding strap with the cover, the manufacturing process is streamlined and simplified, thereby reducing manufacturing time, labor, and costs.

Referring to FIGS. 1-9, the cover and the grounding strap may be formed of a conductive plastic, which is less costly than a metal grounding strap formed of copper, for example. As such, embodiments of the present disclosure eliminate the need for a separate, costly metal grounding strap.

The cover and integrally molded and formed grounding strap may be formed of various plastics, which may be mixed with conductive carbon fiber, conductive carbon powder, and/or the like. The cover and grounding strap may be formed through plastic injection molding processes, for example. The grounding strap may be connected to ground through heat staking, for example. As another example, an end of the grounding strap may be secured to a portion of the vehicle, such as through one or more fasteners (for example, one or more screws).

While various spatial and directional terms, such as top, bottom, lower, mid, lateral, horizontal, vertical, front and the like may be used to describe embodiments of the present disclosure, it is understood that such terms are merely used with respect to the orientations shown in the drawings. The orientations may be inverted, rotated, or otherwise changed, such that an upper portion is a lower portion, and vice versa, horizontal becomes vertical, and the like.

Variations and modifications of the foregoing are within the scope of the present disclosure. It is understood that the embodiments disclosed and defined herein extend to all alternative combinations of two or more of the individual features mentioned or evident from the text and/or drawings. All of these different combinations constitute various alternative aspects of the present disclosure. The embodiments described herein explain the best modes known for practicing the disclosure and will enable others skilled in the art to utilize the disclosure. The claims are to be construed to include alternative embodiments to the extent permitted by the prior art.

To the extent used in the appended claims, the terms “including” and “in which” are used as the plain-English equivalents of the respective terms “comprising” and “wherein.” Moreover, to the extent used in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112(f), unless and until such claim limitations expressly use the phrase “means for” followed by a statement of function void of further structure.

Various features of the disclosure are set forth in the following claims.

1. A fuel intake system for a vehicle, the fuel intake system comprising:
a fuel fill pipe; and
a cover connected to the fuel fill pipe, wherein the cover includes an integrally molded and formed grounding strap extending therefrom.

2. The fuel intake system of claim 1, wherein the cover and the grounding strap are integrally molded and formed from injection-molded plastic.

3. The fuel intake system of claim 1, wherein the cover and the grounding strap are formed from conductive plastic.

4. The fuel intake system of claim 1, wherein the grounding strap is not separately affixed to the cover.

5. The fuel intake system of claim 1, wherein the grounding strap comprises a distal end that connects to ground.

6. The fuel intake system of claim 1, wherein the grounding strap comprises a distal end that is configured to be fixed to another portion of the vehicle through one or more fasteners.

7. The fuel intake system of claim 1, further comprising a mis-fuel inhibitor (MFI) assembly, wherein the MFI assembly includes the cover.

8. The fuel intake system of claim 1, wherein the grounding strap comprises:
an extension beam that outwardly extends from an outer surface of the cover;
an arcuate segment connected to the extension beam;
an extension segment connected to the arcuate segment; and
a hooked end connected to the extension segment.

9. The fuel intake system of claim 1, wherein the grounding strap comprises a loop defining an internal opening, wherein a portion of a fastener that connects to another portion of the vehicle is configured to be retained within the internal opening.

10. A cover configured to connect to a fuel fill pipe of a fuel intake system of a vehicle, the cover comprising:
a main body having an outer surface; and
a grounding strap integrally molded and formed with the main body and extending from the outer surface.

11. The cover of claim 10, wherein the main body and the grounding strap are formed from conductive plastic.

12. The cover of claim 10, wherein the grounding strap is not separately affixed to the main body.

13. The cover of claim 10, wherein the grounding strap comprises a distal end that is configured to connect to ground.

14. The cover of claim 10, wherein the grounding strap comprises a distal end that is configured to be fixed to another portion of a vehicle through one or more fasteners.

15. The cover of claim 10, wherein the cover is part of a mis-fuel inhibitor (MFI) assembly.

16. The cover of claim 10, wherein the grounding strap comprises:
an extension beam that outwardly extends from the outer surface of the main body;
an arcuate segment connected to the extension beam;
an extension segment connected to the arcuate segment; and
a hooked end connected to the extension segment.

17. The cover of claim 10, wherein the grounding strap comprises a loop defining an internal opening, wherein a portion of a fastener that is configured to connect to another portion of the vehicle is configured to be retained within the internal opening.

18. A method of forming a cover of a fuel intake system of a vehicle, the method comprising:
providing a mold that defines a cover-forming cavity having a main body portion and a grounding strap portion connected to the main body portion;
inputting a forming material into the cover-forming cavity to a specified level;
allowing the forming material within the cover-forming cavity to cool and harden;
separating the mold to expose the cover having an integrally molded and formed grounding strap; and
removing the formed cover having the integrally molded and formed grounding strap from the separated mold.

19. The method of claim 18, wherein the forming material comprises conductive plastic.

20. The method of claim 18, wherein the grounding strap portion is configured to form the grounding strap with an extension beam that outwardly extends from an outer surface of the cover, an arcuate segment connected to the extension beam, an extension segment connected to the arcuate segment, and a hooked end connected to the extension segment.
